(19) United States
(12) Patent Application Publication
(10) Pub. No.: US 2013/0126150 A1
(43) Pub. Date: May 23, 2013

(54) FAN CONTROL SYSTEM AND METHOD

(71) Applicants: CHENG-YEN HUANG, Tu-Cheng (TW); SHENG-WEI SU, Tu-Cheng (TW)

(72) Inventors: CHENG-YEN HUANG, Tu-Cheng (TW); SHENG-WEI SU, Tu-Cheng (TW)

(73) Assignee: HON HAI PRECISION INDUSTRY CO., LTD., Tu-Cheng (TW)

(21) Appl. No.: 13/331,562

(22) Filed: Dec. 20, 2011

(30) Foreign Application Priority Data
Nov. 17, 2011 (TW) 100141967

(51) Int. Cl. G05D 23/00

(52) U.S. Cl. 165/300

(57) ABSTRACT

A fan control system for controlling the rotation speed of a number of fans includes one or more first motherboards with baseboard management controllers (BMCs), one or more second motherboards without any BMCs, one or more temperature sensors for detecting the temperature in the area of the second motherboards, and a fan control board (FCB).

Based on determining whether there are any BMCs mounted in the motherboards or not, the FCB reads motherboard temperature from the BMCs mounted in the first motherboards, or reads the temperature from the temperature sensors, thereby controlling the corresponding fans.

### BACKGROUND

1. Technical Field

The present disclosure relates to a fan control system and a fan control method.

2. Description of Related Art

One or more fans controlled by a fan control board (FCB) are mounted in a server for motherboard heat dissipation. A baseboard management controller (BMC) mounted on a motherboard can provide the motherboard temperature in real time to the FCB through an intelligent platform management interface (IPMI), and the FCB can control the rotation speed of the corresponding fan accordingly. However, the FCB cannot control the rotation speed of the fan if the motherboard does not have a BMC.

### BRIEF DESCRIPTION OF THE DRAWING

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a fan control system.

FIG. 2 is a flow chart of an exemplary method for controlling the rotation speed of fans.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

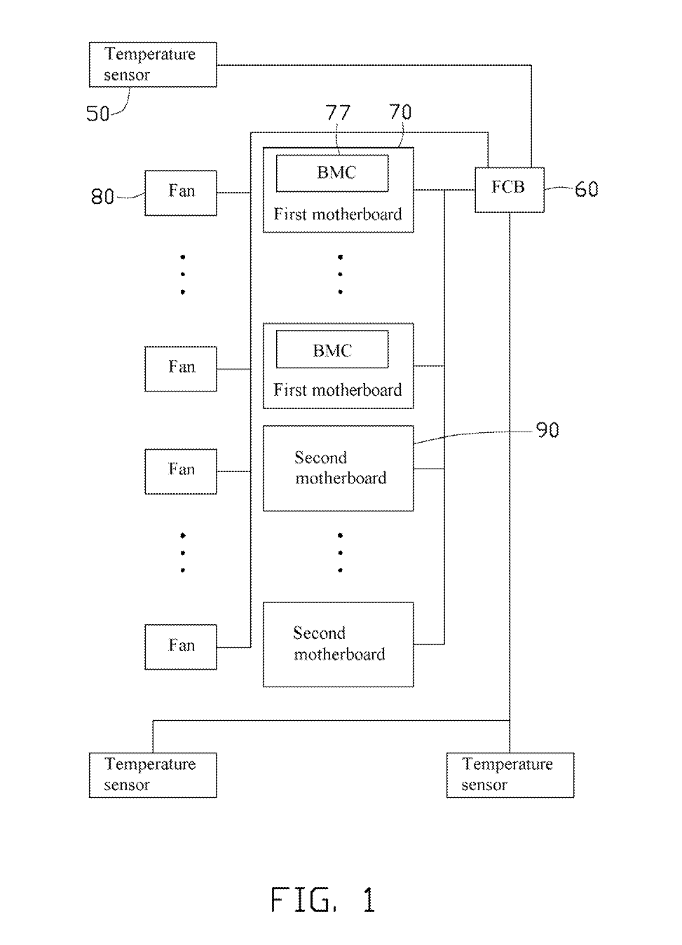

Referring to the FIG. 1, a fan control system is configured for controlling the rotation speeds of a plurality of fans 80 in a data center (not shown). The data center may include a number of racks with each rack holding several servers. Each server will have one of two types of motherboard, either a first motherboard 70 that has a baseboard management controller (BMC) 77, or a second motherboard 90 that does not have a BMC. Also included in the fan control system is a plurality of temperature sensors 50, and a fan control board (FCB) 60.

The first motherboards 70 are connected to the FCB 60. For each of the first motherboards 70 there is a corresponding fan 80 to provide heat dissipation. The BMC 77 mounted on each of the first motherboards 70 provides that motherboard's temperature in real time to the FCB 60.

The second motherboards 90 are connected to the FCB 60. For each of the second motherboards 90 there is a corresponding fan 80 to provide heat dissipation.

The sensors 50 are connected to the FCB 60 by an intelligent platform management bus (IPMB). The sensors 50 may be separately mounted near those servers with the second motherboards 90 for measuring temperature in the area of those servers.

The FCB 60 is connected to the fans 80. The FCB 60 sends an IPMB command, for getting device identification, to all of the motherboards in a predetermined period, thereby determining which of the motherboards are the first motherboards 70, that is, the motherboards with BMCs, because only the motherboards with BMCs will respond. When the FCB 60 receives a response from the BMCs 77 on the first motherboards 70, the FCB 60 sends an IPMB command, for getting sensor readings, to the responding first motherboards 70. The FCB 60 can then adjust or not the rotation speeds of the fans 80 accordingly to either improve heat dissipation where needed or save energy when less heat dissipation is needed. For the second motherboards 90, the FCB 60 reads the temperatures from the sensors 50, and controls the corresponding fans 80 accordingly to provide the proper amount of heat dissipation for the second motherboards 90 without wasting energy.

In this embodiment, the FCB 60 includes a watchdog program for restarting the system program of the FCB 60 when the FCB 60 stops sending the IPMB commands due to system program failures.

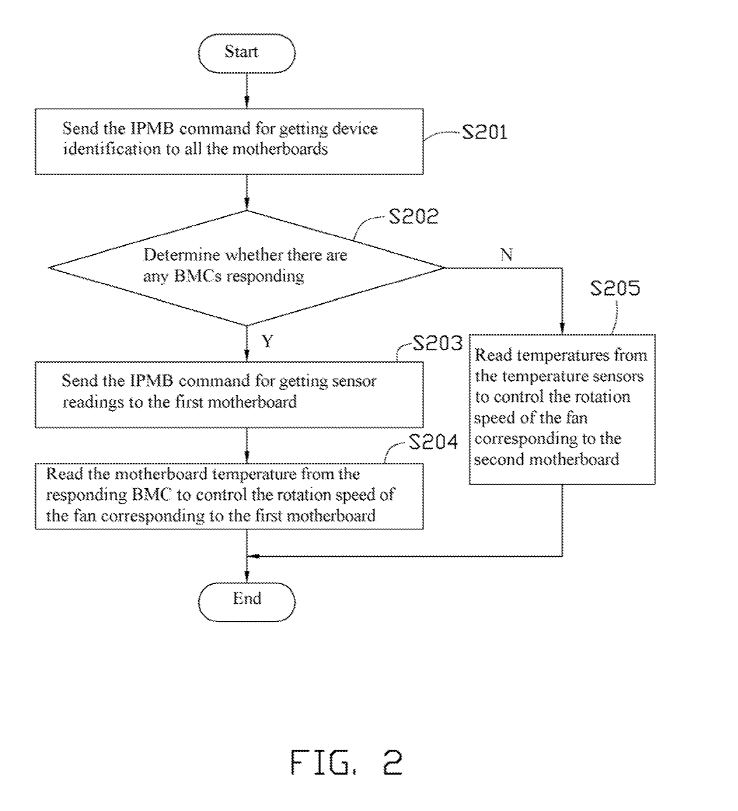

Referring to the FIG. 2, an exemplary method for controlling the rotation speed of the fans 80 includes the following steps:

In step S201, the FCB 60 sends the IPMB command to all the motherboards in turn for getting device identification.

In step S202, the FCB 60 determines whether there are any BMCs responding. For responding BMCs, the procedure goes to step S203. For a motherboard without a

BMC, the procedure goes to step S205.

In step S203, the FCB 60 sends the IPMB command for getting sensor readings to the first motherboard 70.

In step S204, the FCB 60 reads the motherboard temperature from the responding BMC 77 to control the rotation speed of the fan 80 corresponding to the first motherboard 70.

In step S205, the FCB 60 reads temperatures from the temperature sensors 50 to control the rotation speed of the fan 80 corresponding to the second motherboard 90.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A fan control system for controlling the rotation speed of one or more fans in a data center, comprising:
one or more first motherboards each with a baseboard management controller (BMC), wherein each BMC provides the temperatures of the corresponding first motherboard in real time, for each of the first motherboards there is a corresponding fan to provide heat dissipation;
one or more second motherboards without BMCs, for each of the second motherboards there is a corresponding fan to provide heat dissipation;
one or more temperature sensors separately mounted adjacent to second motherboards for measuring the temperature in the area of the second motherboards; and
a fan control board (FCB) connected to the fans, the first and second motherboards, and the temperature sensors, the FCB sending an intelligent platform management bus (IPMB) command for getting device identification to the first and second motherboards, thereby determining which of the motherboards include the BMCs based on whether there are any BMC responses or not;
wherein if the FCB receives responses from the BMCs on the first motherboards, the FCB sends an IPMB command for getting sensor readings to the first motherboards, thereby controlling the rotation speed of the fans corresponding to the first motherboards, if the FCB detects there are no BMC response from the second motherboards, the FCB reads the temperatures from the temperature sensors, thereby controlling the fans corresponding to the second motherboards.

2. The fan control system of claim 1, wherein the FCB comprises a watchdog program for restarting the system program of the FCB when the FCB stops sending the IPMB commands due to a system program failure.

3. The fan control system of claim 1, wherein each of the temperature sensors is connected to the FCB through an IPMB.

4. A fan control method for controlling the rotation speed of one or more fans corresponding to one or more motherboards for heat dissipation, comprising:
sending an intelligent platform management bus (IPMB) command to all the motherboards in turn for getting device identification;
determining whether there are any baseboard management controllers (BMCs) responding;
sending an IPMB command for getting sensor readings to the motherboard with a responding BMC;
reading the motherboard temperature from the responding BMC to control the rotation speed of the fan corresponding to the motherboard with the responding BMC; and
reading temperatures from one or more temperature sensors separately mounted near the motherboards without responding BMCs, thereby controlling the rotation speed of the fan corresponding to the motherboard without a responding BMC if there are no BMC responding.
